(19) United States
(12) Patent Application Publication
(10) Pub. No.: US 2003/0081266 A1
(43) Pub. Date: May 1, 2003

(54) Systems and methods for generating and implementing an image capture procedure for an image capture device

(76) Inventors: Mark David Seaman, Greeley, CO (US); Gregory A. Brake, Fort Collins, CO (US); Robert D. Thompson, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/999,791

(22) Filed: Oct. 31, 2001

(51) Int. Cl. H04N 1/21; H04N 1/04

(52) U.S. Cl. 358/474; 358/302

(57) ABSTRACT

Systems and methods for generating and/or implementing an image capture procedure for an image capture device are provided. One of many possible embodiments is an image capture device for capturing images. Briefly described, one such image capture device comprises: a user interface device; logic comprising information corresponding to an image capture procedure, the image capture procedure enumerating a plurality of predefined situations for capturing an image, the plurality of predefined situations for capturing an image associated with a predefined event; logic for displaying the image capture procedure on the user interface device; and logic for capturing an image.

### TECHNICAL FIELD

The present invention is generally related to image capture devices and is more particularly related to capturing digital images, such as still images and video images.

### BACKGROUND OF THE INVENTION

Presently, there are a variety of devices configured for capturing an image, such as a still image or a video image, and generating an electronic representation of the image. For instance, video recorders and similar devices are commonly used to capture video images. Digital cameras, image scanners, and other similar devices are commonly used to capture still images. These devices are typically configured to enable the images to be stored as digital images on the device. Typically, these devices also enable users to preview the digital images. Some such devices also enable users to download the digital images to a personal computer where they may be stored, edited, or transmitted via a communications network to other devices configured for connection to the communications network.

Digital cameras, video recorders, and other image capture devices are often used at a specific event, such as, for example, a wedding, where a user desires to document the event by capturing a plurality of different images related to the event. Typically, at such an event, a user captures images for a plurality of specific situations. For instance, at a wedding the user may desire to capture an image of the following people and/or situations: the bride and groom, the bride's family, the groom's family, the wedding party, the wedding procession, the wedding vows, and the toasts, to name a few. However, existing image capture devices require the user to capture the images in an adhoc manner. In such situations the user may be experienced enough to know or to have memorized which situations images are to be captured. Nonetheless, this adhoc process may be problematic in situations when the user does not have experience or when there are additional situations or particular customer requirements for capturing images. For example, the user may fail to capture images for certain situations or may fail to meet the particular customer requirements. In order to reduce errors, a prudent user may write down various instructions for capturing images, such as each of the situations for capturing images and any other specific requirements for capturing images. However, the user may still lose the instructions or may neglect to reference the instructions, which may cause the user to fail to capture images for certain situations or fail to meet particular customer requirements.

Thus, there is a need in the industry to address these and/or other deficiencies and inadequacies.

### SUMMARY OF THE INVENTION

The present invention provides systems and methods for generating and/or implementing an image capture procedure for an image capture device.

One of many possible embodiments is an image capture device for capturing images. Briefly described, one such image capture device comprises: a user interface device; logic comprising information corresponding to an image capture procedure, the image capture procedure enumerating a plurality of predefined situations for capturing an image, the plurality of predefined situations for capturing an image associated with a predefined event; logic for displaying the image capture procedure on the user interface device; and logic for capturing an image.

Another embodiment of the present invention is a method for providing image capture services. Briefly described, one such method comprises the steps of: obtaining an image capture procedure, the image capture procedure enumerating a plurality of predefined situations for capturing an image, the plurality of predefined situations for capturing an image associated with a predefined event; displaying information associated with the image capture procedure; and capturing a plurality of images, at least one of the plurality of captured images corresponding to at least one of the plurality of situations for capturing an image.

The present invention may also be viewed as an image capture procedure embodied in a computer-readable medium. Briefly described the image capture procedure comprises: an event source code segment comprising information associated with an event for capturing a plurality of images to be displayed on an image capture device; and a plurality of situation source code segments, each of the plurality of situation source code segments comprising information corresponding to a predefined situation for capturing an image associated with the event that is to be displayed on the image capture device.

The present invention may also be viewed as a computer data signal embodied in a propagation medium. Briefly described, one such computer data signal comprises: an event segment comprising information associated with an event for capturing a plurality of images to be displayed on an image capture device; and a plurality of situation segments, each of the plurality of situation segments comprising information corresponding to a predefined situation for capturing an image associated with the event to be displayed on the image capture device

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of one of a number of possible embodiments of a system for generating and/or implementing an image capture procedure for an image capture device according to the teachings of the present invention.

FIG. 2 is a schematic diagram of one of a number of possible embodiments of an image capture device of FIG. 1 according to the teachings of the present invention.

FIG. 3 is a flow diagram illustrating the architecture, operation, and/or functionality of one of a number of possible embodiments of the image capture procedure generation module of the image capture device of FIG. 2.

FIG. 4 is a data structure diagram illustrating one of a number of possible embodiments of an image capture procedure.

FIG. 5 is a flow diagram illustrating the architecture, operation, and/or functionality of one of a number of possible embodiments of the image capture procedure presentation module of the image capture device of FIG. 2.

FIG. 6 is a screen shot illustrating one of a number of embodiments for presenting an image capture procedure on the user interface device of the image capture device of FIG. 2.

### DETAILED DESCRIPTION OF A PREFERRED EMBODIMENT

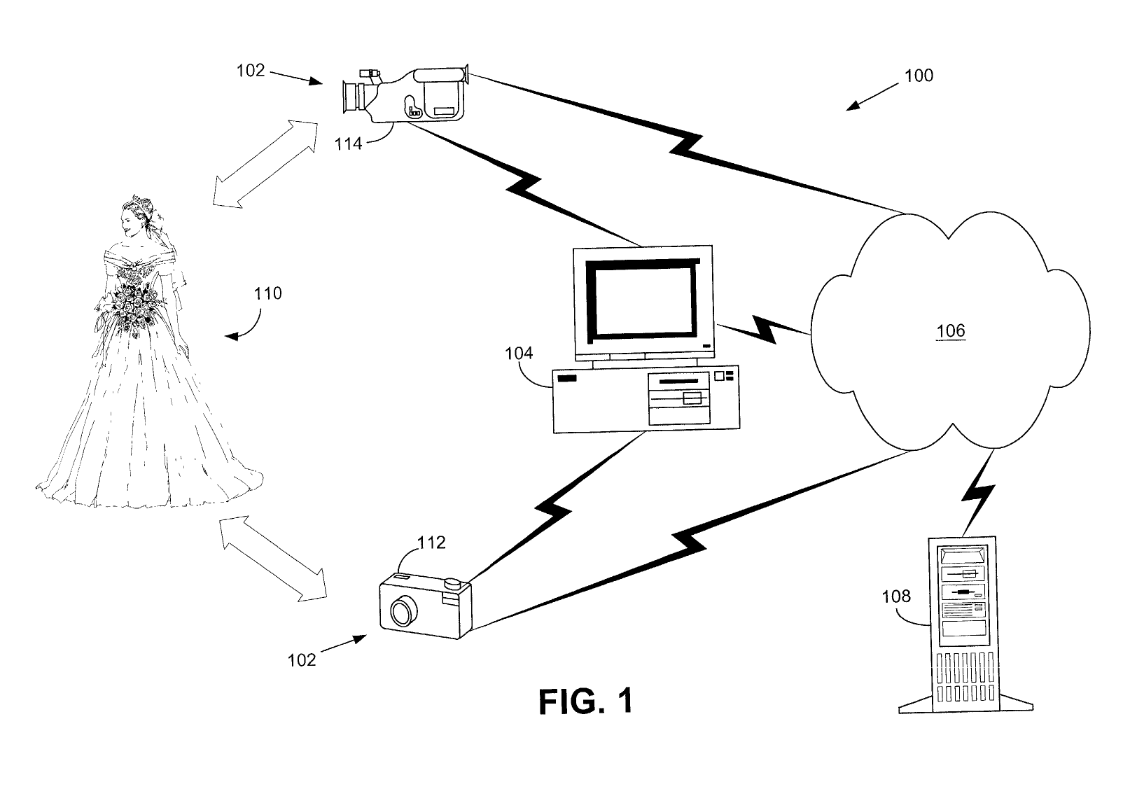

FIG. 1 illustrates a schematic diagram of a system 100 in which an image capture procedure for an image capture device 102 may be generated and/or implemented according to the teachings of the present invention. System 100 may comprise image capture devices 102, a computing device 104, a communications network 106, and a network device 108.

Image capture devices 102 may be any of a variety of devices that are configured to capture an image 110. For example, image capture devices 102 may be a device, such as a digital camera 112 or a scanner, configured to capture a still image. Image capture devices 102 may also be a device, such as a video recorder 114, configured to capture real-time video images and/or audio. As one of ordinary skill in the art will understand, image capture devices 102 may also be any other type of device that is configured to capture digital still images and/or real-time video images. Image capture devices 102 may also be configured to communicate directly with a computing device 104, such as a personal computer, laptop computer, or any other computing device. Furthermore, image capture devices 102 may be configured to communicate via communications network 106 with a network device 108 or any other device connected to communications network 106.

Communications network 106 may be any type or combination of communication networks employing any network topology, transmission medium, or network protocol. For example, communications network 114 may be a local area network (LAN), a metropolitan area network (MAN), a wide area network (WAN), any public or private packet-switched or other data network, including the Internet, circuit-switched networks, such as the public switched telephone network (PSTN), wireless networks, or any other desired communications infrastructure.

As will be understood by one of ordinary skill in the art, the precise configuration of computing device 104, communications network 106, and image capture devices 102 is not critical. As described in detail below, the functionality for generating an image capture procedure for use by an image capture device 102 may be performed by image capture devices 102, computing devices 104, and/or network devices 108. Image capture devices 102 may be configured with the functionality for implementing an image capture procedure.

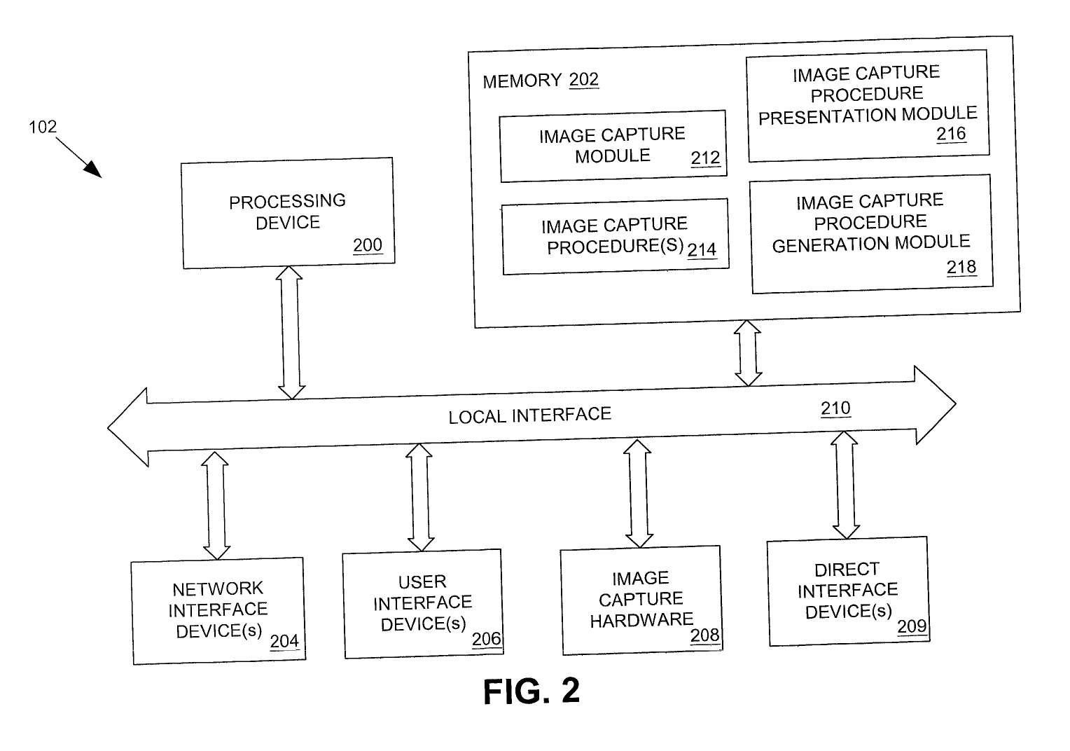

FIG. 2 illustrates a schematic diagram of one of a number of possible embodiments of an image capture device 102 of FIG. 1 for generating and/or implementing an image capture procedure according to the teachings of the present invention. As stated above, image capture device 102 may be any of a variety of devices that are configured to capture an image, such as a still image or a real-time video image. Image capture device 102 may comprise a processing device 200, memory 202, at least one network interface device 204, at least one user interface device 206, image capture hardware 208, and direct interface device(s) 209 interconnected via local interface 210.

Local interface 210 may be, for example but not limited to, at least one bus or other wired or wireless connections, as known in the art. Local interface 210 may comprise additional elements, which are omitted for simplicity, such as controllers, buffers (caches), drivers, repeaters, and receivers, to enable communications. Further, local interface 210 may include address, control, and/or data connections to enable appropriate communications among processing device 200, memory 202, network interface devices 204, user interface devices 206, image capture hardware 208, and direct interface devices 209.

Memory 202 may include any one or combination of volatile memory elements and nonvolatile memory elements. Memory 202 may incorporate electronic, magnetic, optical, and/or other types of storage media. Memory 202 may also have a distributed architecture, where various components are situated remote from one another, but may be accessed by the processing device 200. Memory 202 may comprise an image capture module 212, at least one image capture procedure 214, an image capture procedure presentation module 216, and an image capture procedure generation module 218.

Processing device 200 may be a hardware device for executing software located in memory 202, such as image capture module 212, image capture procedure 214, image capture procedure presentation module 216, image capture procedure generation module 218. Processing device 200 may be any custom-made or commercially-available processor, a central processing unit (CPU), a semiconductor based microprocessor (in the form of a microchip or chip set), a macroprocessor, or generally any device for executing software instructions.

User interface device(s) 206 may comprise at least one function key with which the operation of the image capture device 102 can be controlled by a user. User interface device(s) 206 may also comprise a liquid crystal display (LCD) or other similar display for facilitating the interaction between the user and image capture device 102 and for displaying image capture procedures 214. Furthermore, user interface device(s) 206 may comprise a display for previewing the images captured by the device. Image capture hardware 208 may comprise the components for capturing image 110, generating a digital representation of image 110, and storing the image data in an image database (not shown) in memory 202. As understood by one of ordinary skill in the art, image capture device 102 may further comprise any of a number of other components not illustrated in FIG. 2.

Direct interface device(s) 209 may be configured to facilitate direct communication with a variety of devices, such as, for example, computing device 104. Thus, direct interface device(s) 209 may comprise a data transmitting device and a data receiving device for providing wired and/or wireless communication between image capture device 102 and computing device 104.

Network interface device(s) 208 may be configured to facilitate communication with network device 108 or any other device connected to communications network 106. Thus, network interface device(s) 208 may comprise a data transmitting device and a data receiving device for providing wired and/or wireless communication between image capture device 102 and communication network 106.

Image capture module 212, image capture procedure(s) 214, image capture procedure presentation module 216, and image capture procedure generation module 218 may be implemented in hardware, software, firmware, or a combination thereof. As illustrated in FIG. 2, in one of a number of possible embodiments, image capture module 212, image capture procedure(s) 214, image capture procedure presentation module 216, and image capture procedure generation module 218 are implemented in software or firmware that is stored in memory 202 and that is executed by processing device 200 or any other suitable instruction execution system. If implemented in hardware, as in alternative embodiments, image capture module 212, image capture procedure(s) 214, image capture procedure presentation module 216, and image capture procedure generation module 218 may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Image capture module 212 comprises logic configured to cooperate with image capture hardware 208 for capturing image 110, generating a digital representation of image 110, and storing the image data, for example, in an image database. Image capture module 212 may also comprise logic configured for displaying and/or manipulating the image data, as well as other logic for performing any of a variety of other functions associated with image capture device 102.

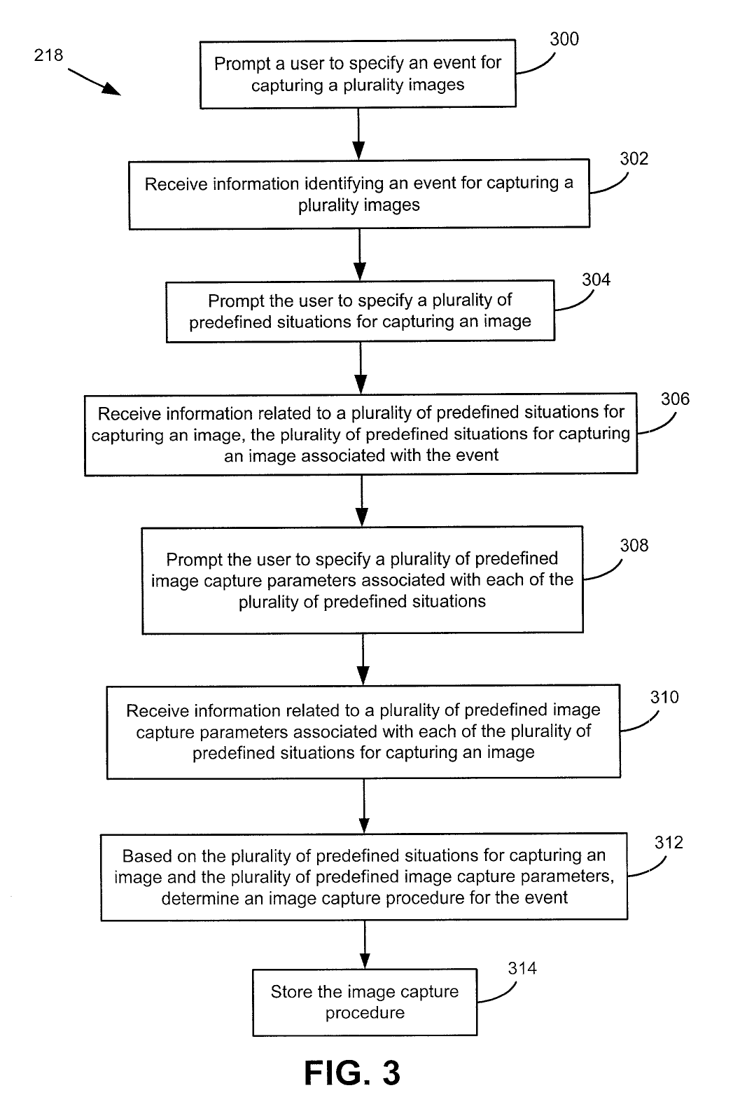

FIG. 3 is a flow diagram illustrating the architecture, operation, and/or functionality of one of a number of possible embodiments of image capture procedure generation module 218 of FIG. 2. Image capture procedure generation module 218 enables a user of image capture device 102 to generate an image capture procedure 214 configured to be used with image capture device 102.

As described in detail below, the image capture procedure 214 generally comprises a list of predefined situations for capturing an image at a specific event, which may be implemented by image capture device 102. In operation, image capture device 102 preferably implements image capture procedure 214 by presenting a list of predefined situations for capturing an image on user interface device 206 associated with image capture device 102. A user that is operating image capture device 102 may view the list of predefined situations for capturing an image. In this manner, image capture procedure 214 provides a user of image capture device 102 a scripted guide for capturing particular images at a specific event.

Referring again to FIG. 3, at block 300, image capture procedure generation module 218 may prompt a user to specify an event for capturing a plurality of images. For example, image capture procedure generation module 218 may prompt the user via user interface device 206. Alternatively, image capture procedure generation module 218 may be configured to enable the user to initiate this process. At block 302, image capture procedure generation module 218 may receive information identifying an event for capturing a plurality of images. As one of ordinary skill in the art will appreciate, the event may be related to any situation in which it is desirable to capture a plurality of images, such as still images or video. For example, the information identifying the event may specify a particular wedding for which a plurality of situations are to captured using the image capture device. Furthermore, as stated above, image capture procedure generation module 218 may be configured to receive this information from user interface device 206.

At block 304, image capture procedure generation module 218 may prompt the user to specify a plurality of predefined situations for capturing an image. Image capture procedure generation module 218 may prompt the user via user interface device 206 or, alternatively, image capture procedure generation module 218 may be configured to enable the user to initiate this process. At block 306, image capture procedure generation module 218 receives information related to a plurality of predefined situations for capturing an image. Each of the plurality of predefined situations may be situations associated with the event for which the user desires to capture an image. Image capture procedure generation module 218 may be configured to receive this information from user interface device 206. By way of example, where the event for capturing a plurality of images is an event, such as a wedding, a user may desire to capture a plurality of different images. Typically, at such an event, a user takes photographs and/or records a plurality of specific situations. For instance, the user may desire to capture an image of the following people and/or situations: the bride and groom, the bride's family, the groom's family, the wedding party, the wedding procession, the wedding vows, and the toasts, to name a few. Thus, the information related to the plurality of predefined situations may comprise information identifying any type of situation and/or person(s) related to the event for which an image is to be captured.

At block 308, image capture procedure generation module 218 may prompt the user to specify a plurality of predefined image capture parameters associated with each of the plurality of predefined situations. Image capture procedure generation module 218 may prompt the user via user interface device 206 or, alternatively, image capture procedure generation module 218 may be configured to enable the user to initiate this process. At block 310, image capture procedure generation module 218 may receive information related to a plurality of predefined image capture parameters associated with each of the plurality of predefined situations for capturing an image. Image capture procedure generation module 218 may be configured to receive this information from user interface device 206. The predefined image capture parameters may comprise any type of information related to the corresponding predefined situation. One of ordinary skill in the art will appreciate that it may be desirable to include further details about the predefined situations for capturing an image. For example, the predefined image capture parameters may include details about any of the following: the subject matter of the image to be captured, who and/or what will be captured in the image, the location for capturing the image, the time the image is to be captured, environmental settings related to the image, recommended settings for image capture device 102, as well as any other desirable details about the predefined situation.

At block 312, image capture procedure generation module 218 may determine, based on the plurality of predefined situations for capturing an image and the plurality of predefined image capture parameters, an image capture procedure 214 for the event. At block 314, image capture procedure generation module 218 may store image capture procedure 214.

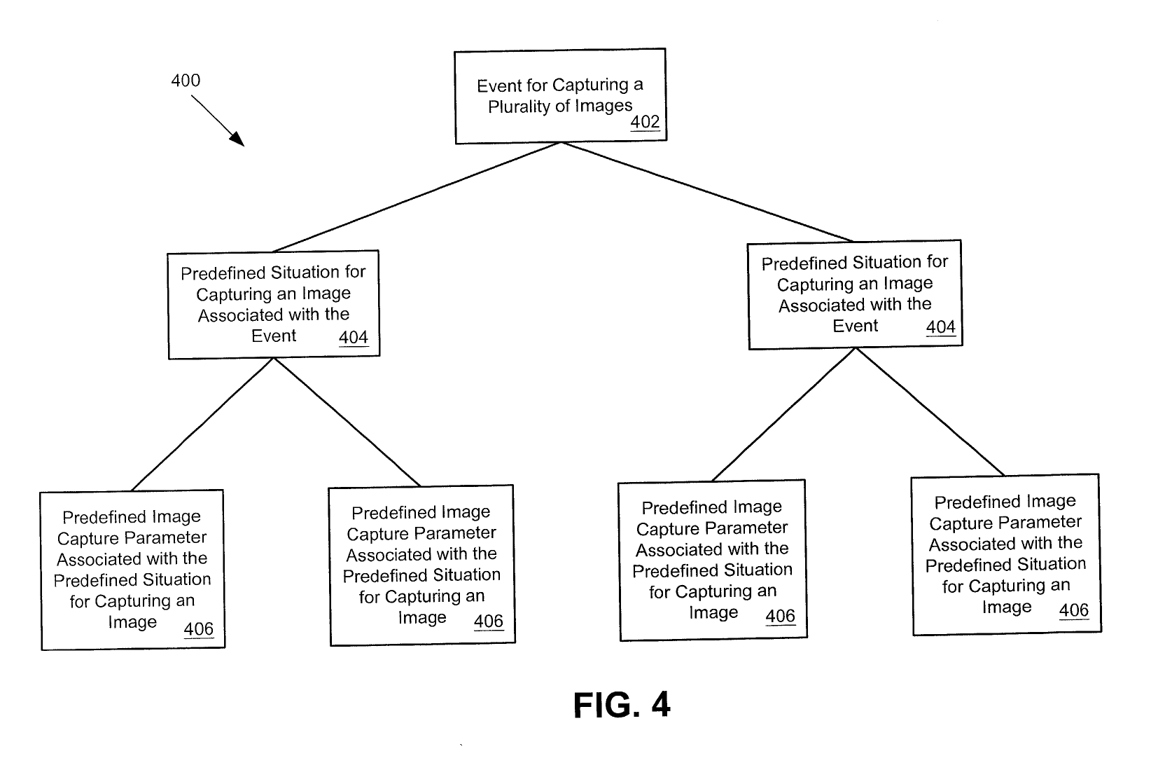

FIG. 4 illustrates a data structure diagram for one of a number of embodiments of an image capture procedure 214 generated by image capture procedure generation module 218. Image capture procedure 214, which comprises a list of information to be presented on user interface device 206 (FIG. 2) of image capture device 102, may be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means now known or later developed, that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. Furthermore, one of ordinary skill in the art will appreciate that image capture procedure 214 may also be a computer data signal embodied in a propagation medium.

As described above and represented at block 402, image capture procedure 214 may include root information related to a specific event for capturing a plurality of images. The event may be related to any situation in which it is desirable to capture a plurality of images, such as still images or video. As shown in blocks 404, image capture procedure 214 may further include information related to a plurality of predefined situations for capturing an image. Each of the plurality of predefined situations for capturing an image are associated with the specific event at block 402. The plurality of predefined situations may comprise information identifying any type of situation and/or person(s) related to the event for which an image is to be captured. Furthermore, each predefined situation may have at least one predefined image capture parameter, represented at blocks 406, associated with the predefined situation for capturing an image. The predefined image capture parameters may comprise further details about the predefined situations for capturing an image.

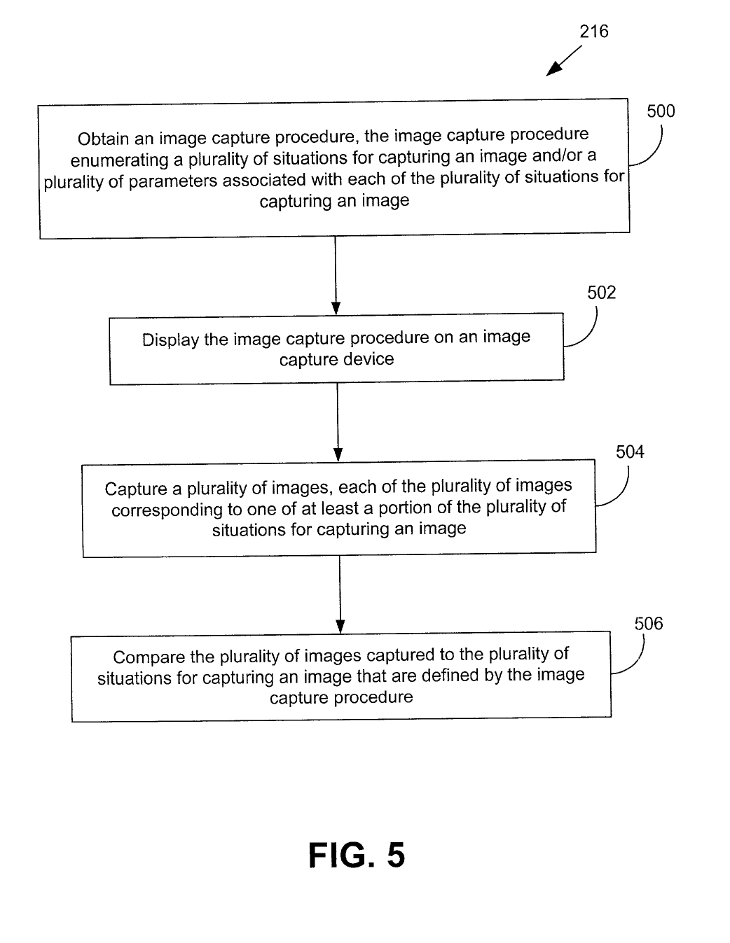

FIG. 5 is a flow diagram illustrating the architecture, operation, and/or functionality of one of a number of possible embodiments of image capture procedure presentation module 216 of FIG. 2 for implementing an image capture procedure 214 on image capture device 102. At block 500, image capture procedure presentation module 216 obtains an appropriate image capture procedure 214 to implement. Image capture procedure 214 may be obtained in a variety of ways. For instance, where the image capture procedure 214 is located in memory 202 in image capture device 102, image capture procedure presentation module 216 may easily access image capture procedure 214. In other embodiments, such as where image capture procedure 214 is not located in memory 202, image capture procedure presentation module 216 may receive image capture procedure 214 via network interface device 204 and/or direct interface device 209. Of course, image capture procedure presentation module 216 may operate in combination with image capture procedure generation module 218 to receive image capture procedure 214 via user interface device 206 as described above.

At block 502, image capture procedure presentation module 216 may display image capture procedure 214 on user interface device 206 on image capture device 102. A user that is operating image capture device 102 may view image capture procedure 214 on user interface device 206. In this manner, image capture procedure 214 provides a user of image capture device 102 a scripted guide for capturing particular images at a specific event.

At block 504, image capture procedure presentation module 216 may enable a user to capture a plurality of images by initiating image capture module 212. Any image may be captured by image capture device 102, including images that do not conform to image capture procedure 214. Nonetheless, when a user employs image capture procedure 214, at least a portion of the images captured should correspond to one of at least a portion of the plurality of situations for capturing an image.

In certain embodiments, image capture procedure presentation module 216 may be configured to merely present image capture procedure 214 as a suggested procedure, which need not be conformed to by the user. In other embodiments, image capture procedure presentation module 216 may include additional security features to ensure that image capture procedure 214 is properly performed. For instance, image capture procedure presentation module 216 may be configured so that a user has to capture at least a portion of the plurality of predefined images. Image capture procedure presentation module 216 may be configured so that the user has to acknowledge having captured an image of one predefined situation before being permitted to capture a subsequent image. Furthermore, image capture procedure presentation module 216 may be configured such that the user has to conform to certain image capture parameters for a specific predefined situation. For instance, when capturing an image of a predefined situation that has a specific recommended setting (image capture parameter) for image capture device 102, image capture procedure presentation module 216 may be configured such that the user has to configure image capture device 102 with the recommended setting before capturing the image. One of ordinary skill in the art will appreciate that image capture procedure presentation module 216 may be configured to provide various other similar functionality.

At block 506, image capture procedure presentation module 216 may compare the plurality of images captured by the user to the plurality of predefined situations for capturing an image and/or the plurality of predefined image capture parameters that are defined by image capture procedure 214. This functionality may be employed in situations where strict conformance to image capture procedure 214 is desirable. In such instances, image capture procedure presentation module 216 may be further configured to provide a comparison report that may be presented on user interface device 206, transmitted to computing device 104 via direct interface device 209, and/or transmitted to network device 108 via network interface device 204.

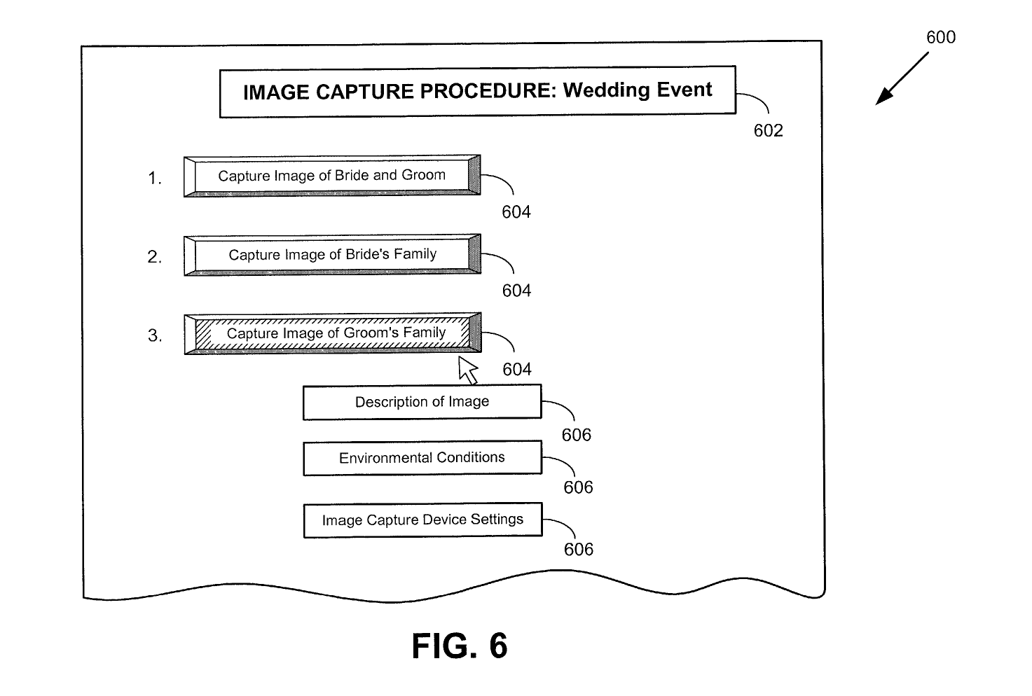

FIG. 6 is an example of a screen shot 600 that illustrates one of a number of embodiments in which image capture procedure presentation module 216 may present image capture procedure 214 on user interface device 206 of image capture procedure 102. Screen shot 600 may include a header portion 602 containing information that corresponds to the root information in image capture procedure 214 that relates to a specific event for capturing a plurality of images represented by block 402 (FIG. 4). Screen shot 600 may also include at least one image capture portion 604 that correspond to the information related to the predefined situations for capturing an image represented by block 404 (FIG. 4) of image capture procedure 214. Each image capture portion 604 may include at least one image parameter portion 606 that correspond to the information related to the predefined image capture parameters represented by block 406 (FIG. 4) in image capture procedure 214. One of ordinary skill in the art will appreciate that image capture procedure presentation module 216 may be configured to present image capture procedure 214 on user interface device 206 in any of a variety of other ways.

As stated above, image capture procedures 214 may also be generated by computing device 104 and/or network device 108. In these instances, computing device 104 and network device 108 may be configured similar to image computing device 102 with a processing drive 200, memory 202, network interface devices 204, user interface devices 206, and direct interface devices 209 interconnected via a local interface 210. Memory 202 may comprise image capture procedure generation module 218 as described above. Thus, image capture procedures 214 may be generated by computing device 104 and/or network device 108 and provided to image capture device 102 via communication network 106 or direct connection to image capture device 102.

Therefore, having thus described the invention, at least the following is claimed:

1. An image capture device, comprising:
a user interface device; and
logic comprising information corresponding to an image capture procedure, the image capture procedure enumerating a plurality of predefined situations for capturing an image, the plurality of predefined situations for capturing an image associated with a predefined event;
logic for displaying the image capture procedure on the user interface device; and
logic for capturing an image.

2. The image capture device of claim 1, wherein the logic comprising information corresponding to an image capture procedure is stored in memory and further comprising a processing device for implementing the logic.

3. The image capture device of claim 1, wherein the logic for displaying the image capture procedure is stored in memory and further comprising a processor device for implementing the logic.

4. The image capture device of claim 1, wherein the image capture procedure further enumerates a plurality of predefined image capture parameters associated with each of the plurality of predefined situations for capturing an image.

5. The image capture device of claim 1, wherein the logic for displaying the image capture procedure is further configured to enable a user to generate the image capture procedure via the user interface device.

6. The image capture device of claim 1, further comprising a network interface device configured to communicate with a network and receive the image capture procedure via the network.

7. The image capture device of claim 1, further comprising a direct interface device configured for direct connection with a computing device and configured to receive the image capture procedure via the direct connection.

8. The image capture device of claim 6, wherein the logic for display the image capture procedure is further configured to provide the image capture procedure to the network.

9. The image capture device of claim 7, wherein the logic for displaying is further configured to transmit the image capture procedure to the computing device.

10. A method for providing image capture services, the method comprising the steps of:
obtaining an image capture procedure, the image capture procedure enumerating a plurality of predefined situations for capturing an image, the plurality of predefined situations for capturing an image associated with a predefined event;
displaying information associated with the image capture procedure; and
capturing a plurality of images, at least one of the plurality of captured images corresponding to at least one of the plurality of situations for capturing an image.

11. The method of claim 10, wherein the image capture procedure is received via a communications network.

12. The method of claim 10, wherein the image capture procedure further enumerates a plurality of predefined image capture parameters associated with each of the plurality of predefined situations for capturing an image.

13. A method for specifying an image capture service for an image capture device configured to capture images, the method comprising the steps of:
obtaining an event for capturing a plurality of images via a user interface device associated with the image capture device;
obtaining a plurality of predefined situations for capturing an image, the plurality of predefined situations for capturing an image associated with the event; and
based on the plurality of predefined situations for capturing an image, determining an image capture procedure for the event.

14. The method of claim 13, further comprising the step of obtaining a plurality of predefined image capture parameters associated with at least one of the plurality of predefined situations for capturing an image.

15. The method of claim 14, wherein the step of obtaining the image capture procedure for the event is further based on the plurality of predefined image capture parameters associated with at least one of the plurality of predefined situations for capturing an image.

16. The method of claim 13, further comprising the step of storing the image capture procedure.

17. An image capture procedure embodied in a computer-readable medium, the computer-readable medium comprising:
an event source code segment comprising information associated with an event for capturing a plurality of images to be displayed on an image capture device; and
a plurality of situation source code segments, each of the plurality of situation source code segments comprising information corresponding to a predefined situation for capturing an image associated with the event that is to be displayed on the image capture device.

18. The image capture procedure embodied in a computer-readable medium of claim 16, further comprising a plurality of image capture parameter source code segments, each of the plurality of image capture parameter source code segments comprising information corresponding to a predefined image capture parameter associated with at least one of the plurality of predefined situations for capturing an image.

19. A computer data signal embodied in a propagation medium, comprising:
an event segment comprising information associated with an event for capturing a plurality of images to be displayed on an image capture device; and
a plurality of situation segments, each of the plurality of situation segments comprising information corresponding to a predefined situation for capturing an image associated with the event to be displayed on the image capture device.

20. The computer data signal of claim 18, further comprising a plurality of image capture parameter segments, each of the plurality of image capture parameter segments comprising information corresponding to a predefined image capture parameter associated with one of the plurality of predefined situations for capturing an image.
